(19) United States
(12) Patent Application Publication
(10) Pub. No.: US 2009/0213061 A1
(43) Pub. Date: Aug. 27, 2009

(54) Display device

(75) Inventor: Kozo Yasuda, Mobara (JP)

Correspondence Address: Stanley P. Fisher;Reed Smith LLP, Suite 1400, 3110 Fairview Park Drive, Falls Church, VA, 22042-4503, US

(73) Assignee: Hitachi Displays, Ltd.

(21) Appl. No.: 12/379,362

(22) Filed: Feb. 19, 2009

(30) Foreign Application Priority Data
Feb. 26, 2008 (JP) 2008-043794

(51) Int. Cl. G09G 3/36

(52) U.S. Cl. 345/100

(57) ABSTRACT

A display device is provided comprising a plurality of pixels disposed in a matrix form in a display area of a substrate, each of the plurality of pixels having a memory which stores written data, a scan line which is provided common to pixels arranged along a row direction and through which a scan signal is supplied to the pixels, and an image line which is provided common to pixels arranged along a column direction and through which an image signal is supplied to the pixels, wherein the scan signal is supplied to the scan line through a vertical address circuit or a vertical shift register circuit, and data is supplied to the image line through a horizontal scan shift register circuit.

### CROSS-REFERENCE TO RELATED APPLICATIONS

The present application claims priority from Japanese application JP 2008-043794A filed on Feb. 26, 2008, the content of which is hereby incorporated by reference into this application.

### BACKGROUND OF THE INVENTION

1. Field of the Invention

The present invention relates to a display device, and, in particular, to a display device having a memory in each pixel in a display area.

2. Description of the Related Art

A display device is discloses in, for example, JP 2006-285118 A in which a memory is provided in each pixel in a display area of a liquid crystal display panel and display data is stored in the memory so that an image is displayed on the liquid crystal display panel even when there is no input data from the outside.

FIG. 5 is a diagram schematically showing a structure of such a liquid crystal display panel. The liquid crystal display panel comprises pixels PX disposed in a display area AR of the liquid crystal display panel in a matrix form and a memory is provided in each of the pixels PX.

Each of scan lines GL is provided common to the pixels PX arranged along a row direction (x direction in FIG. 5). A scan signal is supplied from each of the scan lines GL to the pixels. Each of image lines DL is provided common to the pixels PX arranged along a column direction (y direction in FIG. 5). An image signal (data) is supplied from each of the image lines DL to the pixels.

The scan signal is supplied to each of the scan lines GL by a vertical shift register circuit VSR and the image signal (data) is supplied to each of the image lines DL by a horizontal shift register circuit HSR.

The vertical shift register circuit VSR and the horizontal shift register circuit HSR are controlled by an interface circuit IF.

To the interface circuit IF, signals such as a horizontal synchronization signal HSYNC, a vertical synchronization signal VSYNC, and data are input. The liquid crystal display panel includes an RGB interface.

It is difficult to directly connect such a liquid crystal display panel to a microcomputer or the like. The connection requires a dedicated image processing circuit.

FIG. 6 shows a liquid crystal display panel which can be directly connected to a microcomputer or the like. FIG. 6 is drawn in correspondence to FIG. 5. FIG. 6 differs from FIG. 5 in structure in a Y-address circuit YAD which supplies the scan signal to the scan lines GL and an X-address circuit XAD which supplies data to the image lines DL.

With this structure, a CPU interface signal IFS including signals such as CS, WR, RS, and data is input to the interface IF which controls the Y-address circuit YAD and the X-address circuit XAD.

Such a liquid crystal display panel can be handled by the microcomputer similarly as an SRAM memory.

However, because the liquid crystal display panel of FIG. 6 uses the Y-address circuit YAD and the X-address circuit XAD, the structure of each pixel becomes more complicated, and thus such a structure is disadvantageous when the number of bits is to be increased.

In addition, the Y-address circuit YAD and the X-address circuit XAD have a slower operation speed compared to, for example, a shift register in the RGB interface, and there is also a disadvantage that the power consumption during operation is higher.

### SUMMARY OF THE INVENTION

The present invention has an object to provide a display device in which the structure of the pixel is simplified, the operation-speed is improved, and the power consumption is reduced.

Of the structures of the invention disclosed here, the following are simple summary of the representative structures.

According to one aspect of the present invention, there is provided a display device comprising a plurality of pixels disposed in a matrix form in a display area of a substrate, each of the plurality of pixels having a memory which stores written data, a scan line which is provided common to pixels arranged along a row direction and through which a scan signal is supplied to the pixels, and an image line which is provided common to pixels arranged along a column direction and through which an image signal is supplied to the pixels, wherein the scan signal is supplied to the scan line through a vertical address circuit or a vertical shift register circuit, and data is supplied to the image line through a horizontal scan shift register circuit.

According to another aspect of the present invention, the vertical address circuit and the horizontal scan shift register circuit may be directly scanned by a signal from a CPU which is provided outside of the display device or indirectly scanned by a register in the display device.

According to another aspect of the present invention, the display device may further comprise an interface circuit which controls the vertical address circuit or the vertical shift register circuit and the horizontal scan shift register circuit. A CPU interface signal may be used as an input signal for the interface circuit.

The present invention is not limited to the above-described configurations and various modifications may be made within the scope and spirit of the present invention.

With the display device having such a structure, the structure of the pixel can be simplified, the operation speed can be improved, and the power consumption can be reduced.

### BRIEF DESCRIPTION OF THE DRAWINGS

FIG. 1 is a schematic structural diagram showing an example display device according to a preferred embodiment of the present invention.

FIG. 2 is a structural diagram showing an example interface circuit of a display device according to a preferred embodiment of the present invention.

FIG. 3 is a structural diagram showing an example pixel of a display device according to a preferred embodiment of the present invention.

FIG. 4 is schematic structural diagram showing another example display device according to a preferred embodiment of the present invention.

FIG. 5 is a schematic structural diagram showing an example display device of related art.

FIG. 6 is a schematic structural diagram showing another example display device of related art.

### DETAILED DESCRIPTION OF THE INVENTION

A display device according to a preferred embodiment of the present invention will now be described with reference to the drawings.

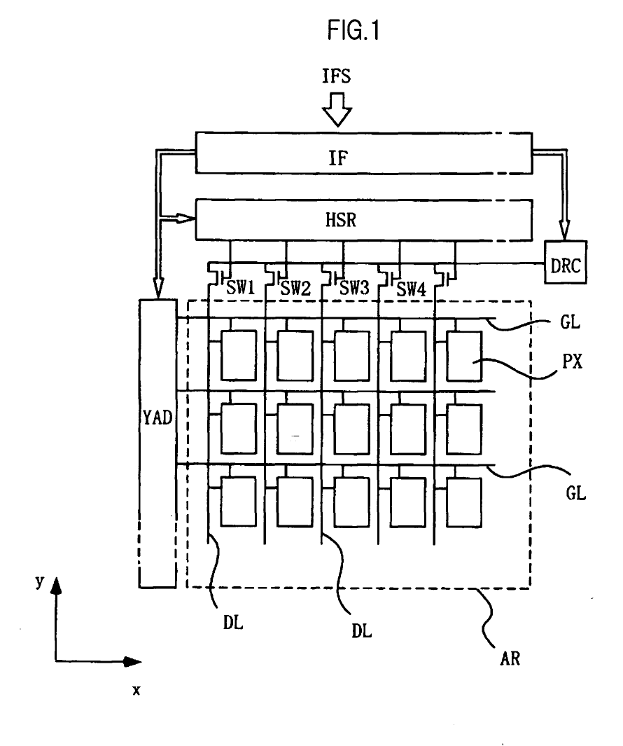

FIG. 1 is a schematic structural diagram showing an example of a display device according to a preferred embodiment of the present invention. FIG. 1 exemplifies a liquid crystal display device.

An equivalent circuit shown in FIG. 1 is formed on a substrate which forms an outer device of a liquid crystal display device (liquid crystal display panel) and which is made of, for example, glass.

A display area AR of the liquid crystal display device is formed on a surface of the substrate and a plurality of pixels PX are disposed and formed in a matrix form in the display area AR of the liquid crystal display device.

Each of scan lines GL is provided common to the pixels PX arranged along the row direction (x direction in FIG. 1). A scan signal is supplied from each of the scan lines GL to the pixels. Each of image lines DL is provided common to the pixels PX arranged along the column direction (y direction in FIG. 1). An image signal (data) is supplied from each of the image lines DL to the pixels.

The scan lines GL are connected to the Y-address circuit YAD, for example, at the left end of FIG. 1, so that the scan lines are sequentially supplied by the Y-address circuit YAD. The Y-address circuit YAD is driven by a drive signal from the interface circuit IF to be described later.

In addition, the device is configured so that data is input through the interface circuit IF, the horizontal shift register circuit HSR, a data latch circuit DRC, etc. to the image lines DL. The interface circuit IF is driven by a CPU interface signal IFS which is input from outside of the liquid crystal display device.

More specifically, the interface circuit IF generates the drive signal based on the CPU interface signal IFS and the horizontal shift register circuit HSR and the Y-address circuit YAD are driven by the drive signal.

Moreover, the interface circuit IF outputs the data in the CPU interface signal IFS to the data latch circuit DRC. The data latch circuit DRC stores the data of one display line. The stored data is output to the image lines DL through switching transistors SW (SW1, SW2, SW3, . . . ) The switching transistors SW are operated by the horizontal shift register circuit HSR and are provided for the image lines DL.

More specifically, the switching transistors SW1, SW2, SW3, . . . are sequentially switched ON by a shift output of high level which is output from the horizontal shift register circuit HSR during one scan period and the image lines DL is connected to a data line DTL extending from the data latch circuit DRC.

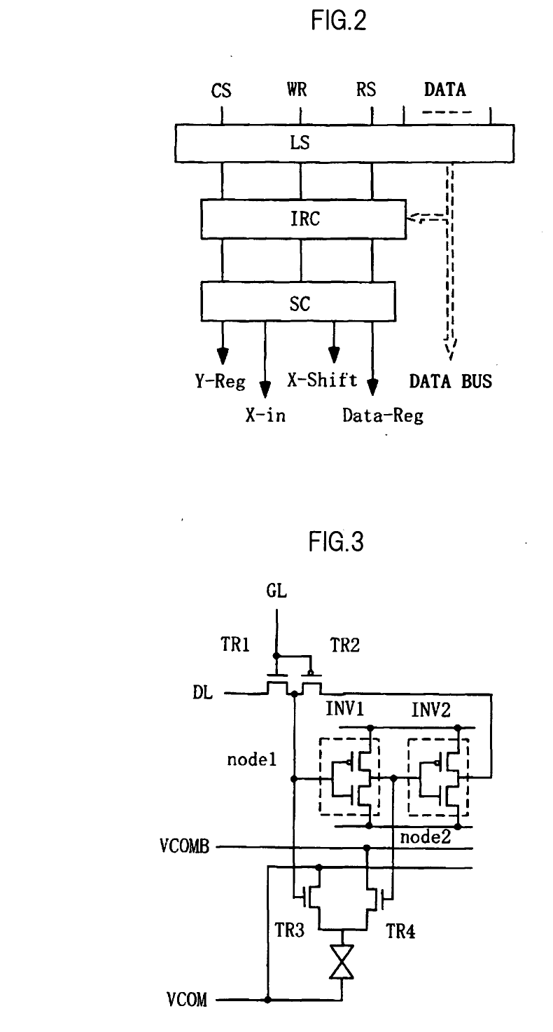

FIG. 2 is a block diagram showing the interface circuit IF in more detail. The interface circuit IF comprises, provided from upstream to downstream, a level shift circuit LS, an index register circuit IRC, and a selector circuit SC. The CPU interface signal IFS comprises various signals such as CS, WR, RS, and data similar to the signal which controls a typical memory, and is input through the level shift circuit LS to the index register circuit IRC. The selector circuit SC outputs a Y-Reg pulse, an X-in pulse, an X-Shift pulse, or a Data-Reg pulse depending on the output from the index register circuit IRC.

Referring again to FIG. 1, the Y-address circuit YAD comprises an array of an n-type MOS transistor and a p-type MOS transistor (not shown). The Y-address circuit YAD is configured with the gate of each transistor connected to a predetermined address line so that one of the scan lines GL is selected corresponding to the input address.

Y-address information is input from the level shift circuit LS through a data bus to the Y-address circuit YAD, and, with the Y-Reg pulse from the selector circuit SC, the Y-address information is stored.

In this case, a scan line selection signal is output to the scan line GL corresponding to the Y-address information.

Then, the data is input from the level shift circuit LS through the data bus to the data latch circuit DRC, and, with the Data-Reg pulse from the selector circuit SC, the data is stored in the data latch circuit DRC. In synchronization with the storage of the data, the start pulse X-in and the transfer pulse X-Shift are input to the horizontal shift register HSR.

FIG. 3 is a diagram showing an example of an equivalent circuit in each of the pixels.

In FIG. 3, each of the pixels comprise a memory comprising a first inverter INV1 and a second inverter INV2 connected in a ring-shape.

The first inverter INV1 has its input terminal connected to a node Node1 and its output terminal connected to a node Node2. The second inverter INV2 has its input terminal connected to the node Node2 and its output terminal connected to the node Node1 (through a transistor TR2).

The transistor TR2 is configured to be switched ON when the memory is in a storage operation.

The node Node1 is configured so that the data (“1” or “0”) from the image line DL is written through a transistor TR1.

When the data of “1” is written to the node Node1, a transistor TR3 is switched ON and a potential of VCOM is applied to a pixel electrode. During this process, the data in the node Node2 is “0” and a transistor TR4 is switched OFF.

When the data of “0” is written to the node Node1, the transistor TR3 is switched OFF and the transistor TR4 is switched ON by the data of “1” in the node Node2. Because the transistor TR4 is switched ON, a potential of VCOMB is applied to the pixel electrode.

The pixel electrode is configured to generate an electric field with an opposing electrode which is placed opposing the pixel electrode with the liquid crystal therebetween, and a potential of VCOM is applied to the opposing electrode.

The voltage of VCOMB is a voltage obtained by inverting the voltage of VCOM with the inverter.

In FIG. 3, the scan line selection signal is input from the vertical shift register circuit to the scan line GL, the transistor TR1 is switched ON, and the transistor TR2 is switched OFF.

In this process, the data (“1” or “0”) from the image line DL is written to the node Node1 through the transistor TR1.

When a scan line non-selection signal is input to the scan line GL, the transistor TR1 is switched OFF and the transistor TR2 is switched ON.

In this process, the data written to the node Node1 is stored in the memory comprising the first inverter circuit INV1 and the second inverter circuit INV2.

In this case, if the display device is a liquid crystal display panel of normally white type, when the data of “1” is written to the node Node1 and the data of “0” is written to the node Node2, a white display is realized in the pixel, and, when the data of “0” is written to the node Node1 and the data of “1” is written to the node Node2, a black display is realized in the pixel.

In this manner, by providing the memory in the pixel, it is possible to stop the operations of the horizontal shift register circuit HSR and the Y-address circuit YAD when it is not necessary to rewrite the image in the display section. As a result, the power consumption can be reduced.

As an alternative configuration of the present embodiment, it is also possible to employ a configuration in which “a pulse-surface-area modulation method” is employed in each of the pixels. More specifically, a configuration may be employed in which a plurality of divided pixel electrodes having areas which differ from each other are formed in each of the pixels, and the circuit of FIG. 3 is formed for each of the pixel electrodes.

By selecting one or a combination of the plurality of pixel electrodes, a predetermined grayscale display can be achieved.

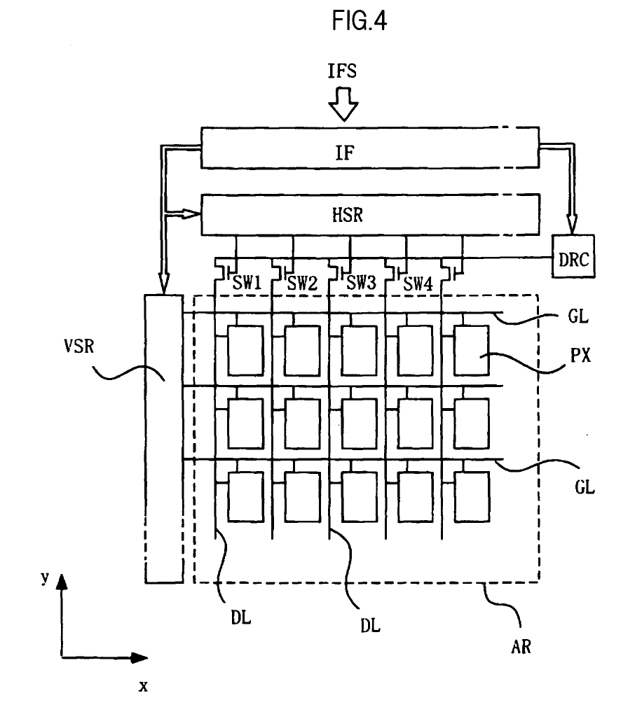

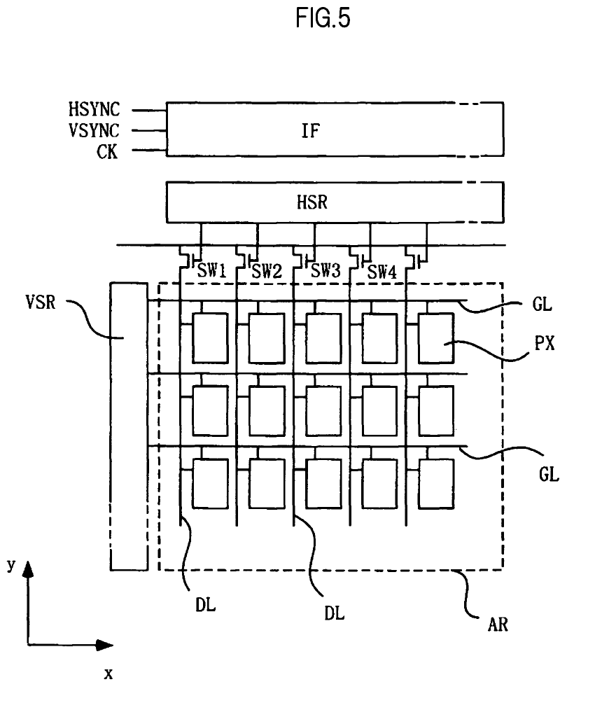

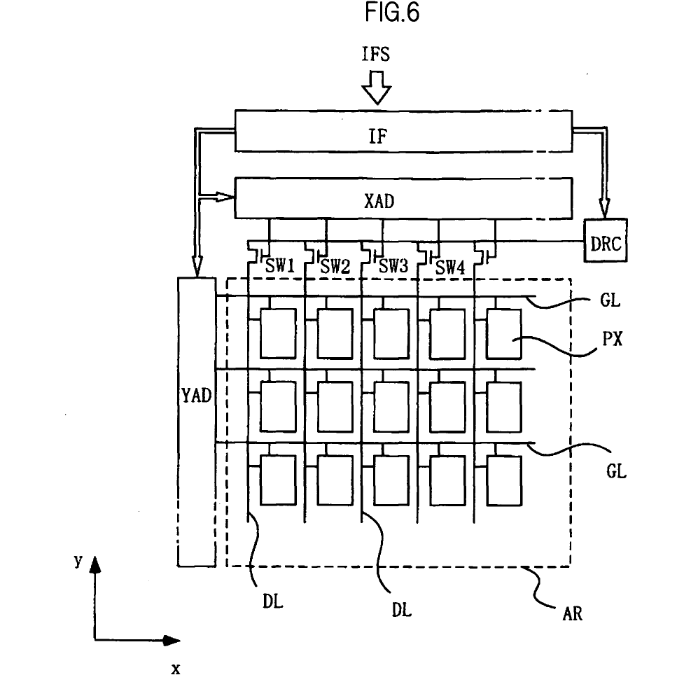

FIG. 4 is a diagram showing another example of a display device according to the present embodiment. FIG. 4 corresponds to FIG. 1.

In FIG. 4, a structure different from that of FIG. 1 is that a vertical shift register circuit VSR connected to each of scan lines GL is provided in place of the Y-address circuit.

In a display device having such a structure, first, the data is input through the data bus to the data latch circuit DRC and, with the Data-Reg pulse, the data is stored in the data latch circuit DRC.

In synchronization with the storage of the data, the start pulse X-in and the transfer pulse X-Shift are input to the horizontal shift register circuit HSR. With this structure, the horizontal shift register circuit HSR sequentially switches the switching transistors SW1, SW2, and SW3 ON, and, with this process, the data from the data latch circuit DRC is transferred through the data line DTL to the corresponding image line DL.

After the data is written to the pixels on one line in this manner, the vertical shift register circuit VSR supplies the scan line selection signal to the scan line GL of the next line.

With repetition of such an operation, the data is written to the entire screen of the display area AR of the liquid crystal display device.

With a display device having such a structure also, the operation speed can be improved and the power consumption during operation can be reduced similar to the display device shown in FIG. 1.

While there have been described what are at present considered to be certain embodiments of the invention, it will be understood that various modifications may be made thereto, and it is intended that the appended claims cover all such modifications as fall within the true spirit and scope of the invention For example, in the above-description, a liquid crystal display device is exemplified, but the present invention is not limited to such a structure and may be applied to other display devices such as an organic electroluminescence display device.

What is claimed is:

1. A display device comprising:
a plurality of pixels disposed in a matrix form in a display area of a substrate, each of the plurality of pixels having a memory which stores written data;
a scan line which is provided common to pixels arranged along a row direction and through which a scan signal is supplied to the pixels; and
an image line which is provided common to pixels arranged along a column direction and through which an image signal is supplied to the pixels, wherein
the scan signal is supplied to the scan line through a vertical address circuit or a vertical shift register circuit, and
data is supplied to the image line through a horizontal scan shift register circuit.

2. The display device according to claim 1, wherein
the vertical address circuit and the horizontal scan shift register circuit are directly scanned by a signal from a CPU which is provided outside of the display device or indirectly scanned by a register in the display device.

3. The display device according to claim 1, further comprising:
an interface circuit which controls the vertical address circuit or the vertical shift register circuit and the horizontal scan shift register circuit, wherein
a CPU interface signal is used as an input signal for the interface circuit.
